(19) United States
(12) Patent Application Publication
(10) Pub. No.: US 2016/0059331 A1
(43) Pub. Date: Mar. 3, 2016

(54) SAWING MACHINE

(71) Applicant: D.I.S. INDUSTRIESÄGEN E.K., Wermelskirchen (DE)

(72) Inventor: Ingo KAMPMANN, Dortmund (DE)

(21) Appl. No.: 14/780,425

(22) PCT Filed: Jun. 4, 2013
(86) PCT No.: PCT/EP2013/061507

§ 371 Date: Oct. 8, 2015

(30) Foreign Application Priority Data
May 15, 2013 (DE) 202013102124.5

(51) Int. Cl. B23D 63/14; B23D 45/02

(52) U.S. Cl. CPC B23D 63/14; B23D 45/022

(57) ABSTRACT

The invention relates to a sawing machine for cutting or separating workpieces (1), in particular a sliding saw, for sawing rolled products such as profiled bars (1) or round bars on the output side of a rolling train, comprising at least one rotating saw blade (2) with saw teeth (SZ), also comprising a transporting device (3) for feeding the workpieces (1) to the sawing machine, also comprising a drive (4) for a sawing slide (5) for advancing the sawing machine while cutting or separating the workpiece (1) in a preselectable cutting plane (SE) by a predetermined advancing increment (H) and for returning the sawing machine after the cutting or separating operation has been performed, and comprising a saw-blade grinding device (7), which can be placed at least with the end face against the saw blade (2) and is intended for at least circumferentially working the saw teeth (SZ). The saw-blade grinding device (7) has at least one braking unit (14, 15).

The invention relates to a power saw for the cutting or severing a workpiece, in particular a sliding saw for sawing rolled products such as profile bars or round bars in an output roller conveyor or on at the downstream end of a rolling train, comprising at least one rotating saw blade with saw teeth, further comprising a supply device, for example a roller conveyor, for feeding the workpiece to the power saw, further comprising a drive for a saw slide for advancing the power saw while cutting or severing the workpiece in a predetermined cutting plane by a predetermined stroke and for returning the power saw after the cutting or severing operation has been performed, and comprising a saw-blade grinder engageable at least with the end face against the saw blade for at least circumferentially machining the saw teeth. The power is saw according to the invention and in particular slide saw may, of course, also be used independently of a rolling train and is used here by way of example for sawing sheet piling or steel profiles.

A power saw of the construction described above and the associated accessories are described in utility model DE 297 22 674. Moreover, power saws without additional saw-blade grinders are used in practice. In such power saws and in particular slide saws, the saw blade typically rotates in a closed protective hood and is cooled by water or compressed air. The sawdust and cooling water are generally discharged into a water tank below the saw blade. The saw blade usually rotates with a peripheral speeds that can reach values of more than 100 m/s. Peripheral speeds up to a maximum of 150 m/s have actually been observed. In contrast, the feed speed of the saw slide during an actual cutting or severing process moves in a range of 0.1 m/s to approximately 1 m/s.

In this way, a so-called fusion cutting is observed in the region of the cutting plane or in the cutting area of the workpiece. This can be attributed to the fact that the workpiece or cutting material is brought to its melting temperature by frictional heat created by the rotating saw blade and is consequently severed or cut. As a result of the material removal in the cutting area or in the region of the cutting plane, a greater or lesser wear of the saw blade can be expected.

In actuality, increased wear is observed in particular on the leading edges of the saw teeth in the direction of rotation of the saw blade. This leads inter alia to rounding, becoming jagged or to breakage. As a consequence thereof, undesired burrs are observed in the cutting plane of the material being or the workpiece to be severed. This must absolutely be avoided, as it results in cost-intensive remachining processes.

Notwithstanding the described burrs, runout is also often observed in practice in the saw blades used. This runout can be attributed, for example, to the fact that the saw blade that is carried on a drive shaft or main shaft of a motor has a bore whose diameter exceeds that of the shaft to a certain (slight) degree. During assembly, the saw blade can thereby be relatively easily and quickly slid onto the shaft in question and fixed thereon. Nevertheless, this may lead in practice and through the introduction of heat to warping, and consequently to the above-described runout. This also leads to a deterioration in cutting performance. In addition, worn saw teeth on a saw blade may promote a possible cracking of the saw blade. Quite apart from this, dull saw blades are associated with increased noise that is likewise regarded as disadvantageous.

In practice, the saw blade is regularly changed upon the occurrence of such problems. Switching a saw blade leads to downtime of the associated power saw that cannot be accepted in connection with the typical continuously running rolling train. As in extreme cases, this leads to stopping the entire rolling train or that a backup may arise in the rolling train. This is undesirable and costly. In addition, the replacement of the saw blades does not directly and necessarily bring an improved cutting result. As a possible runout may also occur with a new saw blade, or an overmachining of the saw blade may occur.

However, attempts were made in the context of the above-described DE 297 22 674 to provide a remedy. The saw-blade grinder proposed in this context has not proven successful in practice. Because defects in the grinding elements and/or material breakages have been observed. Quite apart from this, the use of additional nozzles and supplied abrasive or corundum leads to fouling. This is particularly true for all the bearings of the typically used roller conveyors. In any case, the power saw provided with the associated saw-blade grinder is exposed to strong mechanical stress and increased wear. The invention aims to remedy this as a whole.

The object of invention is to provide a power saw such that possible down times are reduced to a minimum and, at the same time, a perfect cutting of the workpiece is permanently provided at low cost.

To attain this object, a standard power saw is characterized within the framework of the invention in that the saw-blade grinder has at least one brake.

Moreover, the design is for the most part conceived such that the grinding element of the blade grinder is freely rotatable. In principle, however, the saw-blade grinder may also be provided with a separate drive for the grinding element. However as a rule, such a drive is not required, as the grinding element in question begins to rotate by itself. In fact, when engaging the rotating saw blade, the grinding element itself is usually rotated.

Here, the invention proceeds from the understanding that the grinding element is typically designed as an abrasive ball, planar grinding disk, cylindrical abrasive sleeve or abrasive cup. This means that the grinding element is essentially a rotatable body of revolution element that is connected for this purpose to a shaft for rotation about its axis. For the most part, the design is conceived in this regard such that not only the grinding element is supported by the shaft in question, but rather also the brake is connected to the shaft that supports the grinding element.

Since the grinding element can thus rotate on the shaft about the shaft rotation axis, or with the shaft that itself is centered on the rotation axis, when engaging the rotating saw blade, the grinding element itself is entrained and rotates.

As the grinding element can thus rotate with the shaft about the rotation axis defined by the shaft when engaging the rotating saw blade, the grinding element itself is entrained and rotatably driven. Because in this process the rotating saw blade generally drives the grinding element offset from the blade axis, the grinding element undergoes driveless rotation, namely with the aid of the rotating saw blade.

In order to engage the grinding element with the saw blade, an actuator is provided. The actuator not only presses the grinding element radially inward of the blade axis against the saw blade, but also additionally or alternatively aligns it axially with the blade. For this purpose, the actuator is equipped with its own drive. In contrast, the grinding element itself—as described—does not have its own drive.

The actuator generally has two positioning slides. Here, one positioning slide can move radially and ensures that the grinding element is moved in the cutting plane. The cutting plane typically coincides with the saw blade plane spanned by the saw blade. In this way, the positioning slide for radial advancement ensures that the grinding element is radially engaged with a radial outer periphery of the teeth of the saw blade. Of course, an engagement process on the saw blade at something of an angle to the radial direction by the positioning slide in question is also within the scope of the invention. In both cases, the grinding element moves in or along the cutting plane or the saw blade plane either radially in toward the center of the saw blade or at an angle thereto.

In contrast, the other of the two positioning slides is typically responsible as a component of the actuator for a transverse movement relative to the cutting plane or saw blade plane in question. This transverse movement of the grinding element may be perpendicular to the cutting plane or saw blade plane or may also generally be at any angle relative to the cutting plane or saw blade plane.

In this way, the saw tooth to be machined may undergo a multifaceted processing of its shape. In general, one proceeds with the regrinding process provided according to the invention such that the saw tooth being machined with the aid of the saw-blade grinder is provided with a more or less flat outer edge surface. The associated saw tooth thereby ends up with a largely trapezoidal cross-section. This includes a vanishing or very small relief angle.

The relief angle is the angle of inclination of the outer upper surface of the saw tooth relative to the horizontal in the direction of rotation of the saw blade. Of course, according to need one may also in principle define any desired relief angle of the respective saw tooth with the aid of the saw-blade grinder. In addition, the possibility exists of setting the grinding element at an angle to the saw blade or the saw tooth to be machined. The respective saw tooth may thereby be angled and provided with an angle relative to the cutting plane or saw blade plane.

It is a particular advantage of mention in the saw-blade grinder that is quasi-integrated into the power saw is that possible runout as well as wobbling movements of the saw blade are automatically compensated out or can be compensated out. As the saw blades are typically made of heavy plates, they do not fulfill any increased requirements on their flatness and any tolerances of material thickness. In this connection, the grinding element as a whole ensures a so-called blending of the saw blade or the corresponding saw tooth, so that at the end of processing, a uniform radius as seen across the total circumference can be observed. This means that, with the aid of the integrated saw-blade grinder, any manufacturing inconsistencies of the saw blade and/or its mounting and/or its drive can be equalized and compensated out.

In addition, the saw-blade grinder according to the invention typically does not require a drive, but rather the grinding element is mostly designed as such to be driveless. If a is drive is necessary, this is usually used (only) for the actuator, with the help of which the grinding element is pressed against the saw blade and/or aligned with the saw blade.

Nevertheless, in order to ensure in this design that the peripheral speed of the grinding element does not exceed critical levels, the peripheral speed of the grinding element may be variably set by a brake. Here, the invention proceeds from the understanding that such grinding elements typically perform at peripheral speeds in the range between 30 m/s to 60 m/s. In contrast, higher peripheral speeds may lead to damaging the grinding element and must therefore be avoided. This is achieved particularly elegantly and simply according to the invention by the brake.

To this end, the grinding element is usually associated with a rotational speed sensor. The values recorded by the rotational speed sensor may be processed by a controller. In general, the brake is operated by the controller. In this way, the controller ensures in conjunction with the brake that the grinding element is held in the specified range with respect to its peripheral speed between, for example, 30 m/s and 60 m/s, in any case performing no impermissibly high peripheral speeds.

For this purpose, the brake is typically connected—as already described—to a shaft that carries the grinding element. It has proven useful if the brake and the grinding element are provided substantially on opposite ends of the shaft. The brake may as such be any conceivable brake, for example a friction brake, in particular a disk brake, a fluid brake, an eddy current brake or also a combination thereof.

Finally, it is within the scope of the invention that the machining of the saw teeth or the saw blade is performed, optionally repeatedly, by the saw-blade grinder during rolling pauses. In this way, pauses or breaks provided in the rolling process are used advantageously to remachine the saw blade in the power saw. To this end, the saw-blade grinder integrated according to the invention in the power saw has proved particularly advantageous. The actual grinding process can be performed and carried out such that the saw teeth of the saw blade retain the desired contour or are restored to it. It is primarily important to sharpen the leading edges in the direction of rotation. In addition, the saw-blade grinder shows itself to be advantageous in equalizing any manufacturing inconsistencies, such as runout of the installed and rotating saw blade.

All this is possible while taking into account lower costs as well while producing a particularly robust construction. In addition, no external power supply is typically necessary, because the actuator for the grinding element can also in principle be operated manually. Finally, the saw-blade grinder may be advantageously connected to an already existing protective hood, so that installation and mounting are also easy and inexpensive. The substantial advantages may be seen herein.

The invention is hereinafter described in greater detail with reference to drawings showing only one embodiment.

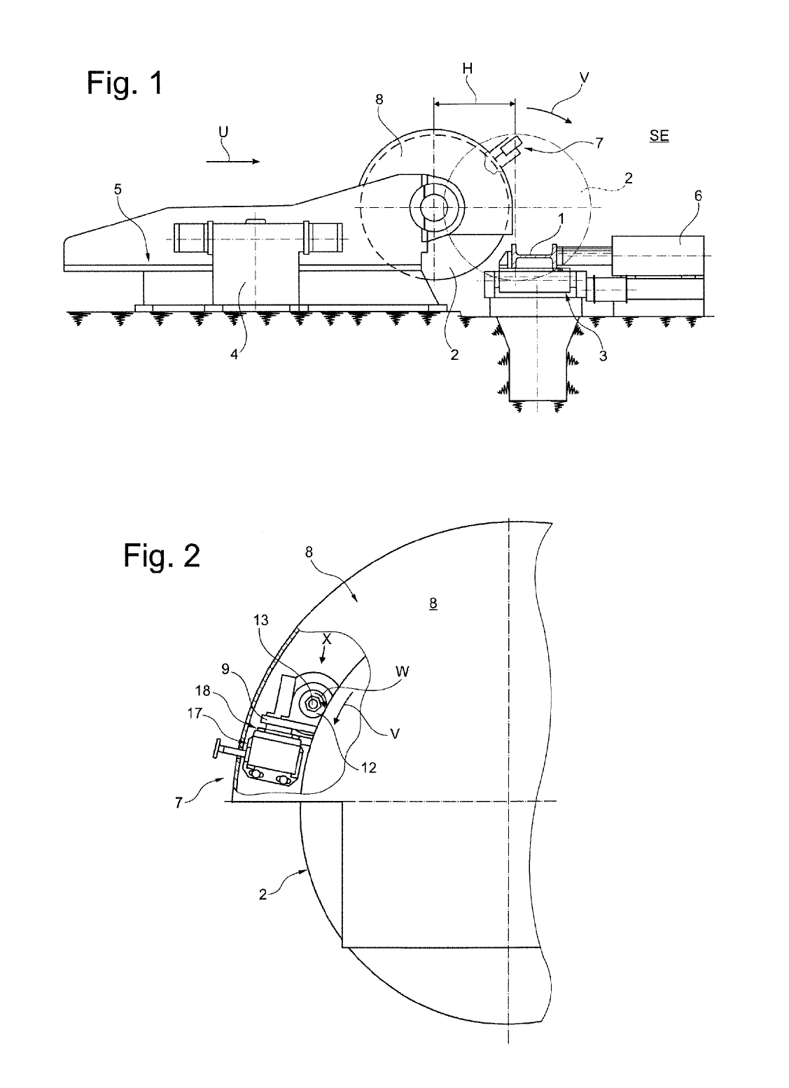

FIG. 1 is a side view of a power saw according to the invention,

FIG. 2 is a detail of FIG. 1 partially cut away in the region of the protective hood with the saw-blade grinder attached thereto,

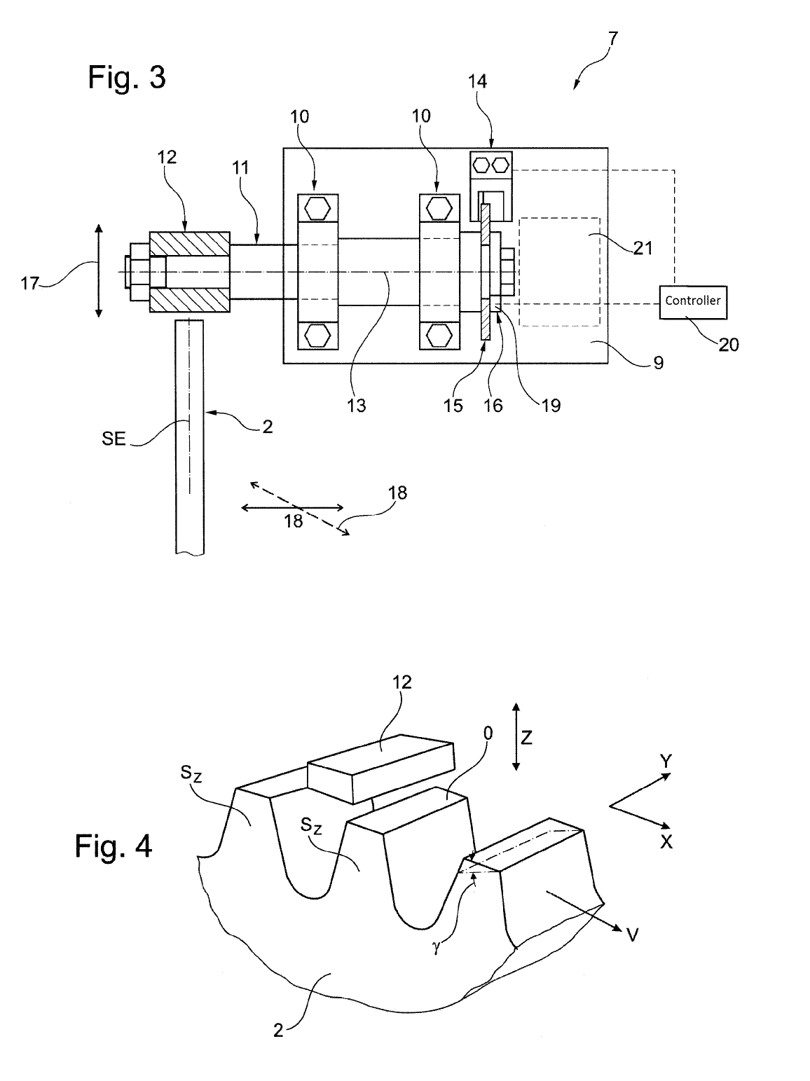

FIG. 3 is a schematic view in the X direction according to FIG. 2 of the saw-blade grinder, and

FIG. 4 is a perspective view of a machined saw blade.

In the figures, a power saw for cutting or severing a workpiece 1 is shown. This can be a sliding power saw for the sawing of rolled products. The rolled products are profile bars 1 or round bars on at the output/downstream end of a rolling train. The profile bars 1 or round bars in question are supplied for the cutting process by an output roller conveyor of the concerned rolling train. The sliding power saw shown is a circular saw and may function as a cold power saw. In the illustrated embodiment, it is a hot power saw for hot sawing the profile bar 1.

The power saw is equipped in its basic construction with a rotating saw blade 2 and a supply device 3. The supply device 3 is a roller conveyor 3 serving for example as the output of the rolling train. The saw blade 2 carries on its outer periphery an array of saw teeth SZ. In the illustrated embodiment of the power saw, the profile bar 1 is supplied by the roller conveyor/supply device 3 in a conveying direction here meaning perpendicular to the view plane of FIG. 1. In addition, a saw slide 5 has a drive 4 that, while cutting or severing the profile bar 1, can advance the power saw in a predetermined cutting plane SE by a predetermined advancing increment or stroke H. This takes place at a feed speed U.

This means that moving or advancing the saw slide 5 by the drive 4 into the dot-dashed position of the saw blade 2 shown in FIG. 1 severs or separates the profile bar 1 supplied by the supply device 3. So that the profile bar 1 does not slip or otherwise move back and forth during sawing, a hold-down 6 is provided that clamps the profile bar 1 during cutting or severing.

After completing the cutting process, the saw slide 5 is returned back to the position shown in solid lines by the drive 4. The advance and return of the power saw at the feed speed U generally occurs horizontally. In principle, the power saw and the profile bar 1 may also operate vertically, so that relative vertical movement is possible.

Of particular importance to the invention is a saw-blade grinder 7 engageable with the outer edge of the saw blade 2. The saw-blade grinder 7 in this case is detachably fixed on a shield hood 8 for the saw blade 2. To this end, the shield hood 8 has with an optionally closable opening shown in FIG. 1. In the embodiment of FIG. 2, the saw-blade grinder 7 is inside the shield hood 8.

In the detailed view according to FIG. 2 of the saw-blade grinder 7 according to the invention, an arrow X shows the view direction of FIG. 3. That is, FIG. 3 is a view of the subject according to FIG. 2 taken in the direction of the arrow X. Consequently, it can be seen with reference to FIGS. 2 and 3 that the saw-blade grinder 7 as a whole is mounted on a base plate 9. Bearing blocks 10 mounted on this base plate 9 support a shaft 11. The shaft 11 can therefore rotate about an axis 13 with in the bearing blocks 10. A grinding element 12 is provided on one end of the shaft 11.

In the context of FIG. 2, the grinding element 12 is a cylindrical abrasive sleeve. In principle, however, the grinding element may also be formed as an abrasive ball, a flat grinding disk or an abrasive cup. FIG. 2 shows that the saw blade 2 rotates with a peripheral speed V. The saw blade rotating at this peripheral speed V moves in a cutting plane SE on displacement through the stroke H. In the illustrated embodiment, the cutting plane SE coincides with the plane of the drawing of FIG. 1. In addition, the cutting plane SE is largely identical with a plane in which lies the saw blade.

As soon as the grinding element 12 is engaged with the saw blade 2, the rotation of the saw blade 2 is transferred to the grinding element 12. As a consequence thereof, the grinding element 12 rotates about the axis 13 with its own peripheral speed W, as shown in FIG. 2. Normally the grinding element 12 does not have its own drive, although a drive 14 [21] indicated in broken lines in FIG. 3 is possible and encompassed by the invention.

Thus, as soon as the grinding element 12 comes into contact with the rotating saw blade 2, the peripheral speed V of the saw blade 2 ensures that the grinding element 12 is also rotated with its own peripheral speed W. FIG. 2 shows that in the area of engagement or contact, both feed speeds V and W are the same. The saw-blade grinder 7 itself is provided according to the invention with at least one brake 14, 15, [15, 16] so that the peripheral speed W of the grinding element 12 is held in the permissible range of approximately 30 m/s to 60 m/s. The brake 14, 15 [15, 16] is a friction brake, and in particular a disk brake 14, 15 [15, 16] with a brake disk 15 and a brake caliper 14 that can grip the brake disk 15. The brake disk 15 is mounted on the end on the shaft 13. For this purpose, a lock washer 16 is provided. The grinding element 12 is located at the opposite end of the shaft 13.

Based on a comparison of FIGS. 2 and 3, it can be detected that the grinding element 12 is engaged with the saw blade 2 and/or moved relative to the saw blade 2 by an actuator 17, 18. The actuator 17, 18 consists in this embodiment of two positioning slides 17, 18, and may be connected to the base plate 9. Here, the positioning slide 17 radial shifts the grinding element 12 relative to the saw blade 2 in the cutting plane SE. The other positioning slide 18 acts in contrast as a transverse slide relative to the cutting plane SE or the saw blade plane in question. This means that, the further positioning slide 18 moves the grinding element 12 transversely to the saw blade 2 and the cutting plane SE or also obliquely thereto, as indicated by the dotted and solid lines in FIG. 3.

The peripheral speed W of the grinding element 12 can be variably set by the brake 15, 16. To this end, the grinding element 12 is associated with a rotational speed sensor 19 that in the illustrated embodiment according to FIG. 3 is on the end of the shaft 11, adjacent the lock washer 16 or integrated therein. The rotational speed sensor 19 transmits its output to a controller 20. With the aid of the controller 20, the brake 14, 15 can now be so operated that the peripheral speed W of the grinding element 12 is held in the permissible range. For this purpose, the controller 20 operates the brake caliper 14 and presses it in this embodiment against the brake disk 15 or lifts the brake caliper 14 from the brake disk 15, so that the desired peripheral speed W of the grinding element 12 is set.

The indicated grinding element 12 ensures that the saw-blade grinder 7 can work the saw tooth SZ schematically indicated in FIG. 4 such that the respective saw tooth SZ is given a more or less flat outer or upper end face O. In this way, the saw tooth SZ is given a largely trapezoidal shape. Moreover, the invention ensures that the front edge of the saw tooth SZ in the indicated direction of rotation or the corresponding feed speed V is sharpened. Here, a very small relief angle γ is often machined in, or even entirely without such a relief angle γ. Such a relief angle γ is the angle of inclination of the outer or upper surface O relative to the horizontal in the direction of rotation of the saw blade 2 indicated with the aid of the feed speed V. FIG. 4 further shows that in principle, the grinding element 12 can be moved in all three spatial directions x, y, z by the positioner 17, 18.

As already explained above, the saw-blade grinder 7 can ensure the machining of the saw teeth SZ during rolling pauses. For this purpose, the actuator 17, 18 may also be connected to the controller 20. Once the controller 20 receives in this case an instruction regarding a rolling pause or other interruption of the manufacturing process of the workpiece 1 to be cut, the controller 20 subsequently ensures that, the actuator 17, 18 engages the grinding element 12 with the saw blade 2 to be machined.

1. A power saw for cutting or severing a workpiece, the saw comprising:
at least one rotating saw blade with saw teeth;
a supply device for feeding the workpiece to the power saw;
a drive for a saw slide for advancing the power saw while cutting or severing the workpiece in a predetermined cutting plane by a predetermined stroke and for returning the power saw after the cutting or severing operation has been performed;
a saw-blade grinder engageable radially inward relative to a rotation axis of the saw blade at least with an outer edge of the saw blade for at least circumferentially machining the saw teeth; and
at least one brake.

2. The power saw according to claim 1, wherein the grinding element of the saw-blade grinder is freely rotatable.

3. The power saw according to claim 2, wherein the grinding element is an abrasive ball, planar grinding disk, cylindrical abrasive sleeve or abrasive cup.

4. The power saw according to claim 2, further comprising:
an actuator for pressing the grinding element against the saw blade and/or moving the grinding element relative to the saw blade.

5. The power saw according to claim 4, wherein the actuator is provided with two positioning slides.

6. The power saw according to claim 5, wherein one of the positioning slides moves radially in the cutting plane and the other of the positioning slides moves transversely relative to the cutting plane.

7. The power saw according to claim 2, wherein, when engaging the rotating saw blade, the grinding element itself is rotated by frictional engagement with the saw blade.

8. The power saw according to claim 7, wherein a peripheral speed of the grinding element is variably set by the brake.

9. The power saw according to claim 2, further comprising:
a rotational speed sensor connected to the grinding element producing an speed-related output; and
a controller connected to the sensor for operating the brake in accordance with a rotational speed of the grinding element detected by the sensor.

10. The power saw according to claim 2, further comprising:
a rotatable shaft on which the grinding element is rotationally fixed and extending parallel to an axis of the blade, the brake being connected to the shaft.

11. The power saw according to claim 10, wherein the brake and the grinding element are provided substantially on opposite ends of the shaft.

12. The power saw according to claim 1, wherein the brake is a disk brake, a fluid brake, an eddy-current brake or a combination thereof.

13. The power saw according to claim 1, wherein the machining of the saw teeth is performed by the saw-blade grinder during rolling pauses.

14. The power saw according to claim 1 wherein the saw blade is moved in a straight line by the drive in the stroke, whereby the power saw is a slide saw.
